(19) United States
(12) Patent Application Publication
(10) Pub. No.: US 2026/0365121 A1
(43) Pub. Date: Nov. 19, 2026

(54) MOUNTING STRUCTURE FOR AUTOMOTIVE SOUNDPROOFING MATERIAL

(71) Applicants: Howa Co., Ltd., Kasugai-shi (JP); TOYOTA JIDOSHA KABUSHIKI KAISHA, Toyota-shi (JP)

(72) Inventors: Mitsutoshi IIDA, Kasugai-shi (JP); Akihiro ORINO, Kasugai-shi (JP); Naoki IKUHARA, Kariya-shi (JP)

(21) Appl. No.: 19/677,065

(22) Filed: May 14, 2026

(30) Foreign Application Priority Data
May 16, 2025 (JP) 2025-082537

(51) Int. Cl. B60R 13/08

(52) U.S. Cl. CPC B60R 13/0838; B60R 2013/0807

(57) ABSTRACT

A mounting structure attaches an automotive soundproofing material to a base component such as a vehicle body panel. The structure includes a protrusion projecting from a surface of the base component and the automotive soundproofing material attached to the base component by utilizing the protrusion. To facilitate sliding installation, the protrusion includes an inclined portion with a height that gradually decreases in a reverse direction. Furthermore, the protrusion includes a locking portion that faces an acting force received from the automotive soundproofing material to restrict movement in the reverse direction without requiring additional fasteners.

### CROSS-REFERENCE TO RELATED APPLICATIONS

This application claims the benefit of priority under 35 U.S.C. § 119 to Japanese patent application serial number 2025-082537 filed May 16, 2025, the contents of which are incorporated herein by reference in their entirety for all purposes.

### FIELD OF THE DISCLOSURE

The present disclosure relates generally to acoustic insulation mechanism, and more particularly, to a mounting structure for securing automotive soundproofing materials to vehicle body panels or similarly base components without necessarily requiring separate mechanical fasteners.

### BACKGROUND

Automotive soundproofing materials, such as dash silencers, are commonly attached to a dash panel to reduce the transmission of engine and road noise into the passenger compartment. Traditional installation methods often rely on mechanical fasteners such as clips, bolts, or screws, which require corresponding through-holes to be formed in the soundproofing material. For example, the dash silencer attached to the cab side of the dash panel is fixed at a plurality of locations by bolts. Ridge-shaped cuts are formed at the mounting locations of the dash silencer, and by allowing the bolts to pass through these cuts, portions of the mounting locations of the dash silencer protrude from the engine room side toward the passenger compartment interior side.

The presence of through-holes in the soundproofing material can create acoustic leaks, potentially degrading the overall sound absorption and sound insulation performance of the material. Furthermore, securing the material with multiple separate mechanical fasteners often necessitates manual alignment and assembly, which can increase manufacturing cycle times and labor costs.

Accordingly, there is a need for an improved mounting structure that facilitates efficient installation while maintaining acoustic integrity.

### SUMMARY

The following presents a simplified summary of the disclosure in order to provide a basic understanding of some aspects of the disclosure. This summary is not an extensive overview of the disclosure. It is not intended to identify key or critical elements of the disclosure or to delineate the scope of the disclosure. According to one aspect of the present disclosure, a mounting structure for automotive soundproofing material attaches a soundproofing material to a base component, such as a body-side panel. The mounting structure includes a protrusion projecting from the surface of the base component and a soundproofing material disposed along the surface. The protrusion defines a locking surface that faces an acting force exerted by the soundproofing material, thereby restricting movement of the soundproofing material relative to the base component.

This configuration allows the soundproofing material to be securely positioned relative to the base component without necessarily providing holes for mechanical fasteners, such as bolts or clips. Consequently, holes that could cause noise leakage at the mounting positions where the protrusions are provided become unnecessary, and degradation of the sound absorption performance and sound insulation performance of the soundproofing material can be suppressed. Furthermore, attaching the soundproofing material utilizing the protrusions facilitates installation of the soundproofing material to the vehicle body panel or interior trim components, thereby reducing the effort of the mounting work and shortening the man-hours. An effect of preventing incorrect installation can also be expected. Therefore, the efficiency of the mounting work for the soundproofing material can be improved.

According to another aspect of the present disclosure, the protrusion is configured such that the protruding amount from the surface of the base component gradually decreases in the direction of the force received from the soundproofing material. With this configuration, in the forward direction in which the height of the protrusion increases, the frictional resistance between the mounting surface of the soundproofing material and the protrusion becomes relatively small. Therefore, by aligning the direction of attachment of the soundproofing material along the surface of the base component with the forward direction, the soundproofing material can be smoothly attached to the surface of the base component. On the other hand, in the reverse direction, the soundproofing material is locked by the locking surface of the protrusion, and positional displacement can be prevented. Accordingly, positioning of the soundproofing material relative to the surface of the base component is facilitated.

According to another aspect of the present disclosure, the protrusion has the locking surface (locking portion) and an inclined surface (inclined portion) on which the protruding amount from the surface of the base component gradually decreases from the locking surface along the direction of the force received from the soundproofing material.

According to another aspect of the present disclosure, the soundproofing material is attached to the base component in an elastically deformed state. The protrusion includes a first protrusion having the locking surface that receives a first acting force which is gravity caused by the weight of the soundproofing material, and a second protrusion having the locking surface that receives a second acting force caused by a restoring force of the soundproofing material that tends to return to its original shape. With this configuration, the soundproofing material can be effectively held by utilizing the acting forces acting in two different directions.

According to another aspect of the present disclosure, the surface of the base component includes a plurality of faces facing different directions. The soundproofing material is elastically deformed by being disposed along the plurality of faces. Therefore, the soundproofing material is disposed across a plurality of different faces of the base component, and the soundproofing material is held in position by protrusions provided on at least one of the plurality of faces.

According to another aspect of the present disclosure, the surface of the base component is recessed as viewed from the passenger compartment side.

According to another aspect of the present disclosure, the protrusion is formed integrally with the base component. This makes it possible to reduce the number of parts.

According to another aspect of the present disclosure, the protrusion is a separate member from the base component. This allows the protrusion to be retrofitted to the base component. Therefore, by appropriately setting the number and orientation of the protrusions, the magnitude of the frictional resistance against the acting force can be adjusted.

### BRIEF DESCRIPTION OF THE FIGURES

FIG. 1 is a schematic side view illustrating the general arrangement of a mounting structure for an automotive soundproofing material within a vehicle, according to one embodiment of the present disclosure.

FIG. 2 is a schematic front elevation of a dash panel to which the soundproofing material is attached.

FIG. 3 is a schematic cross-sectional view of the mounting structure of taken along line III-III of FIG. 2.

FIG. 4 is a schematic diagram illustrating an example of an acting force caused by gravity.

FIG. 5 is a perspective view illustrating the configuration of an individual protrusion.

FIG. 6 is a schematic cross-sectional view illustrating the installation of a mounting surface of the soundproofing material along a molded surface.

FIG. 7 is an enlarged, partial perspective view of a left corner of the dash panel, illustrating acting forces when the soundproofing material is disposed thereon.

FIG. 8 is a schematic cross-sectional view of the mounting structure taken along line VIII-VIII of FIG. 2.

FIG. 9 is a schematic diagram illustrating an example of an acting force caused by a restoring force of the soundproofing material.

FIG. 10 is a schematic cross-sectional view illustrating a modified embodiment of the mounting structure utilizing a mechanical fastener.

FIG. 11 is a perspective view illustrating an alternative configuration of the protrusion formed as a hollow structure.

FIG. 12 is a schematic front elevation view of the dash panel illustrating another alternative configuration wherein the protrusion is separately attached member.

### DETAILED DESCRIPTION

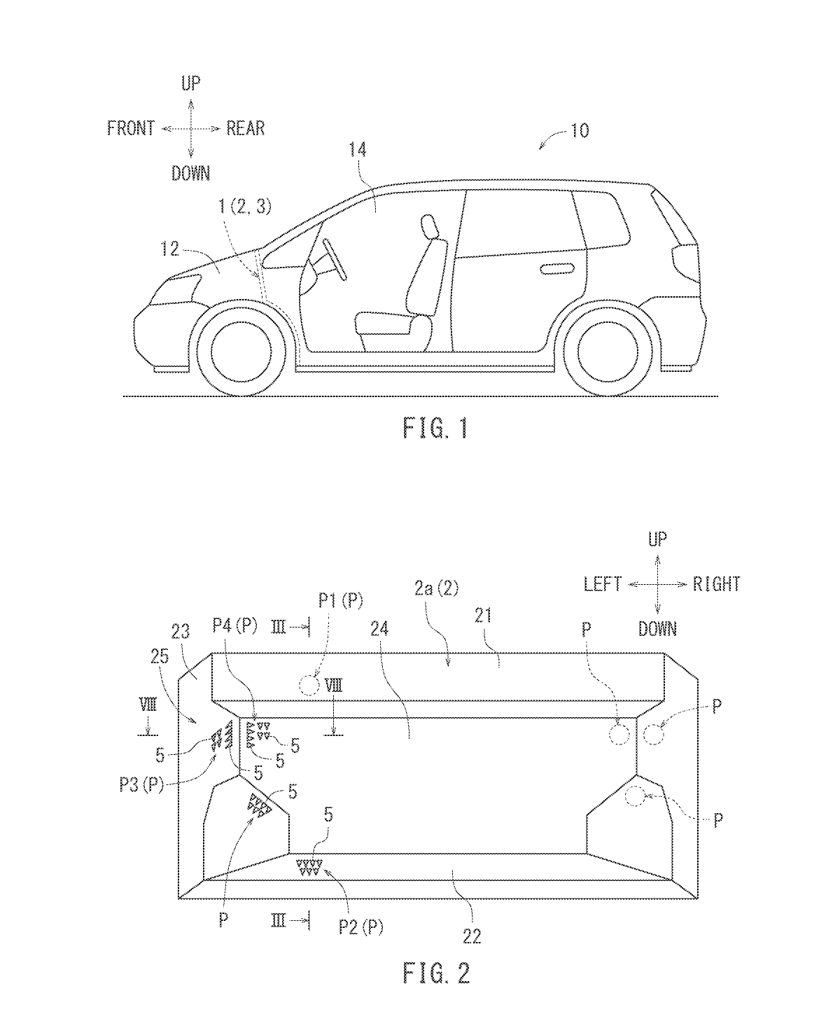

Various embodiments of the present disclosure will now be described with reference to the drawings. As shown in FIG. 1, a mounting structure 1 for an automotive soundproofing material is described herein using a mounting structure of the soundproofing material 3 to a dash panel 2 (which is a base component or vehicle body panel) as an exemplary embodiment. The dash panel 2 is a partition wall that separates the engine room 12 and the passenger compartment space 14 of the automobile 10. The directional terms used herein, such as up/down, front/rear, and left/right, correspond to the standard orientation as viewed in the forward traveling direction of the automobile 10.

As shown in FIG. 1, the dash panel 2 is arranged at the front side of the passenger compartment space 14 and separates the engine room 12 and the passenger compartment space 14 of the automobile 10. The dash panel 2 may be formed from various materials, including, but not limited to, a metal cast panel, an injection-molded resin panel, a sheet metal panel, or the like. It may also have a configuration combining a metal cast panel and an injection-molded resin panel. Various materials such as steel plate, aluminum alloy plate, or iron plate may be selected. The dash panel 2 is formed in a size and shape corresponding to the model and type of the automobile 10.

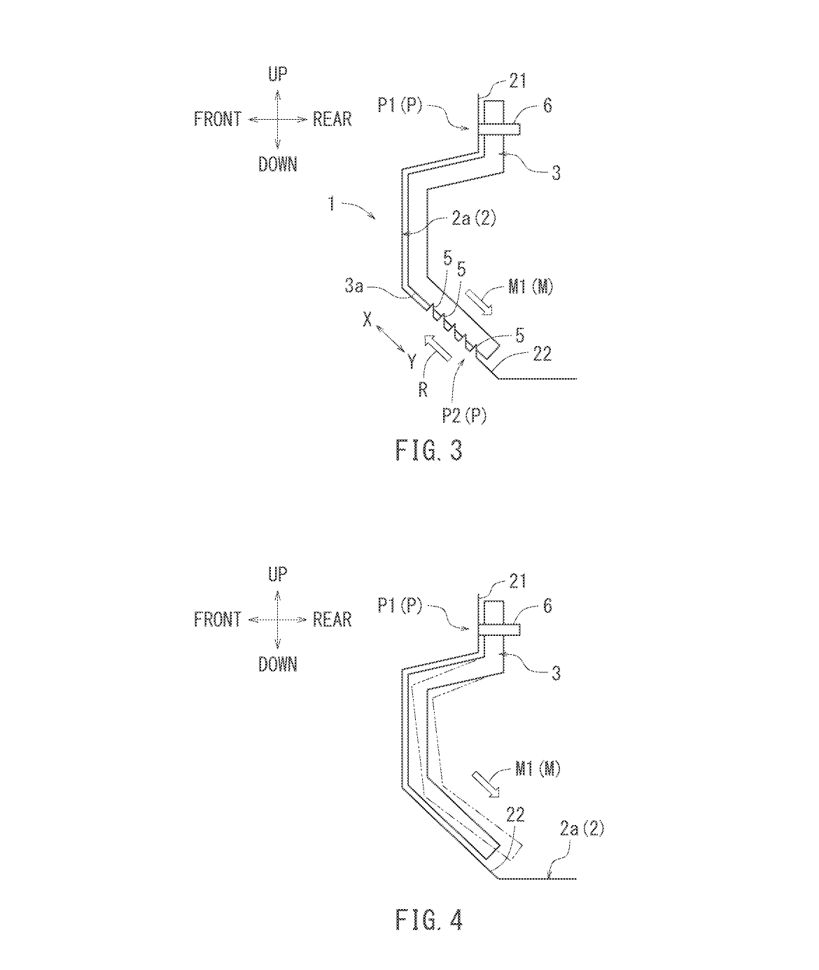

As shown in FIG. 3, the soundproofing material 3 is mounted on the passenger compartment side of the dash panel 2 to reduce the propagation of noise (e.g., engine noise) from the engine room 12 to the passenger compartment space 14. The soundproofing material 3 may comprise felt, polyurethane, and similar acoustic materials. In some embodiments, the soundproofing material 3 may comprise a laminated structure, such as a sound-absorbing (e.g., low-density felt) and a sound-insulating layer (e.g., high-density felt). Additional layers, such as a thermoplastic resin sound-insulating sheet or a non-air-permeable film layer, may also be included. The soundproofing material 3 may also have a configuration in which a sound-insulating sheet made of a thermoplastic resin film or the like is laminated between the sound-absorbing layer and the sound-insulating layer. Furthermore, the soundproofing material 3 may have, for example, a configuration in which a foamed polyurethane layer having sound insulation properties and a non-air-permeable film layer are laminated. The soundproofing material 3 is generally sheet-shaped and is sized and contoured to correspond to a molded surface 2a of the dash panel 2 and the range in which it is mounted. The density and the like of the material constituting the soundproofing material 3 are set according to the required sound absorption performance and sound insulation performance.

As shown in FIG. 2, a plurality of mounting positions P for attaching the soundproofing material 3 are set on the molded surface 2a on the passenger compartment side of the dash panel 2. The dash panel 2 includes a plurality of faces having different molded surface 2a directions, and the soundproofing material 3 is mounted across these various faces. Mounting positions P are established on at least one of these faces to secure the soundproofing material 3 and prevent displacement or detachment of the soundproofing material 3 relative to the molded surface 2a.

For example, referencing FIG. 3, the soundproofing material 3 is disposed along the molded surface 2a extending from an upper edge to a lower edge of the dash panel 2. The mounting positions P are established at an upper face 21 and an inclined face 22 located on the lower edge side of the dash panel 2. Among these mounting positions P, the protrusions 5 are disposed at least some of the mounting positions P. At a mounting position P2 on the inclined face 22, the protrusions 5 are arranged in alignment. The protrusions 5 project outwardly from the molded surface 2a. A mounting surface 3a of the soundproofing material 3 physically contacts these protrusions 5. Conversely, at the mounting position P1 on the upper face 21, the soundproofing material 3 may be fixed by a mechanical fastener 6 (e.g., a screw, bolt, or clip).

When the soundproofing material 3 is installed along the molded surface 2a, an acting force M acts on the mounting surface 3a, creating a tendency for the mounting surface 3a to shift from the mounting position P along the surface of the molded surface 2a. For example, as shown in FIG. 4, a first acting force M1, primarily induced by gravity, acts on the soundproofing material 3 along the inclined face 22 on the lower edge side. The first acting force M1 acts such that the soundproofing material 3 hangs down due to its own weight. The magnitude of this acting force M varies depending on the inclination angle in the surface direction of the molded surface 2a, the material of the soundproofing material 3, and the like. As shown in FIG. 3, the protrusions 5 are structured to interface with the mounting surface 3a to resist the acting force M be generating a frictional force R between the mounting surface 3a and the protrusions 5. When the frictional force R is equal to or greater than the acting force M, the mounting surface 3a is positionally restricted at the mounting position P2. At the mounting position P2 on the inclined face 22 on the lower edge side, the soundproofing material 3 is positioned and held relative to the molded surface 2a by the frictional force R acting between the protrusions 5 and the soundproofing material 3. Accordingly, the soundproofing material 3 is secured by a mechanical anchor effect created by the protrusions 5.

Turning to FIG. 5, in one embodiment, the protrusion 5 comprises a generally triangular pyramid shape formed integrally with the dash panel 2. The protrusion 5 has an inclined portion 5a and a locking portion 5b (defining a facing surface). The inclined portion (inclined surface) 5a corresponds to the hypotenuse and lateral faces of the triangular pyramid shape, and the height of the protrusion 5 projecting from the molded surface 2a changes in the length L direction. The locking portion 5b corresponds to the base of the triangular pyramid shape, and is situated at the end side where the protrusion height of the inclined portion 5a is greatest. The protrusion 5 has the greatest height H at the one end side where the locking portion 5b is provided, and the height of the protrusion decreases toward the tip 5c at the other end side. When the protrusion 5 is viewed from the front of the molded surface 2a, the protrusion 5 is formed in a tapered shape in which the width W at the locking portion 5b is greatest and the width decreases toward the tip 5c. The height of the protrusion 5 changes along the acting direction in which the acting force M acts. That is, the height of the protrusion 5 gradually decreases along the acting direction of the acting force M at the inclined portion 5a.

The locking portion 5b is the portion with the largest triangular cross-sectional area, and faces the mounting surface 3a of the soundproofing material 3 when it moves along the molded surface 2a in the acting direction of the acting force M, thereby suppressing the movement of the soundproofing material 3. On the other hand, the cross-section of the protrusion 5 decreases in area toward the tip 5c. With this configuration, the direction in which the height of the protrusion 5 increases coincides with the forward direction X, in which the frictional resistance between the mounting surface 3a of the soundproofing material 3 and the protrusion 5 is relatively small. The direction opposite to the forward direction X is the reverse direction Y, in which the frictional resistance is relatively large. In the present embodiment, the height and width dimensions of the protrusion 5 increase toward the forward direction X, so that the cross-sectional area increases.

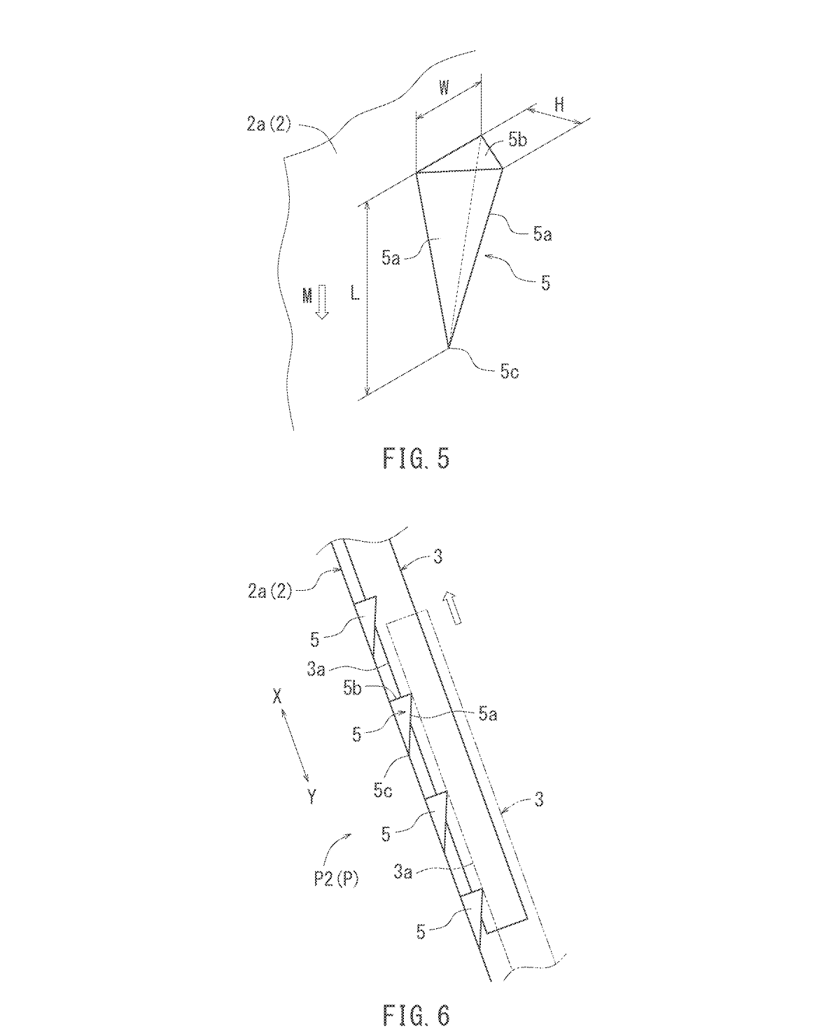

At the mounting position P2 on the inclined face 22 on the lower edge side, the reverse direction Y of the protrusion 5 is set in the first acting direction in which the first acting force M1 acts. As shown in FIG. 6, the direction of attaching the soundproofing material 3 is set to the forward direction X of the protrusion 5, and the soundproofing material 3 is attached by allowing the mounting surface 3a of the soundproofing material 3 to conform to the molded surface 2a. This makes the frictional resistance between the mounting surface 3a of the soundproofing material 3 and the protrusion 5 relatively small, allowing the soundproofing material 3 to be disposed at the mounting position P2 while sliding the mounting surface 3a. After the soundproofing material 3 is attached, the acting force M acts in the reverse direction Y, where the frictional resistance is relatively large. Therefore, a frictional force R greater than the acting force M acts between the mounting surface 3a of the soundproofing material 3 and the protrusion 5, thereby holding the soundproofing material 3 at the mounting position P2.

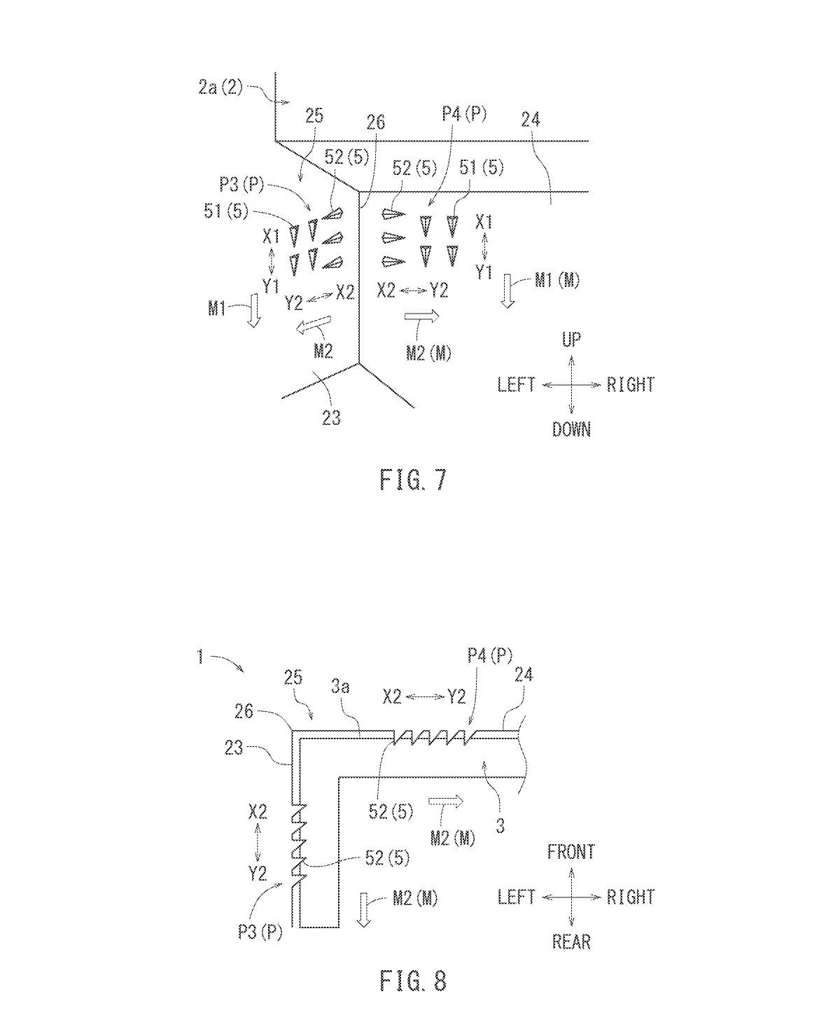

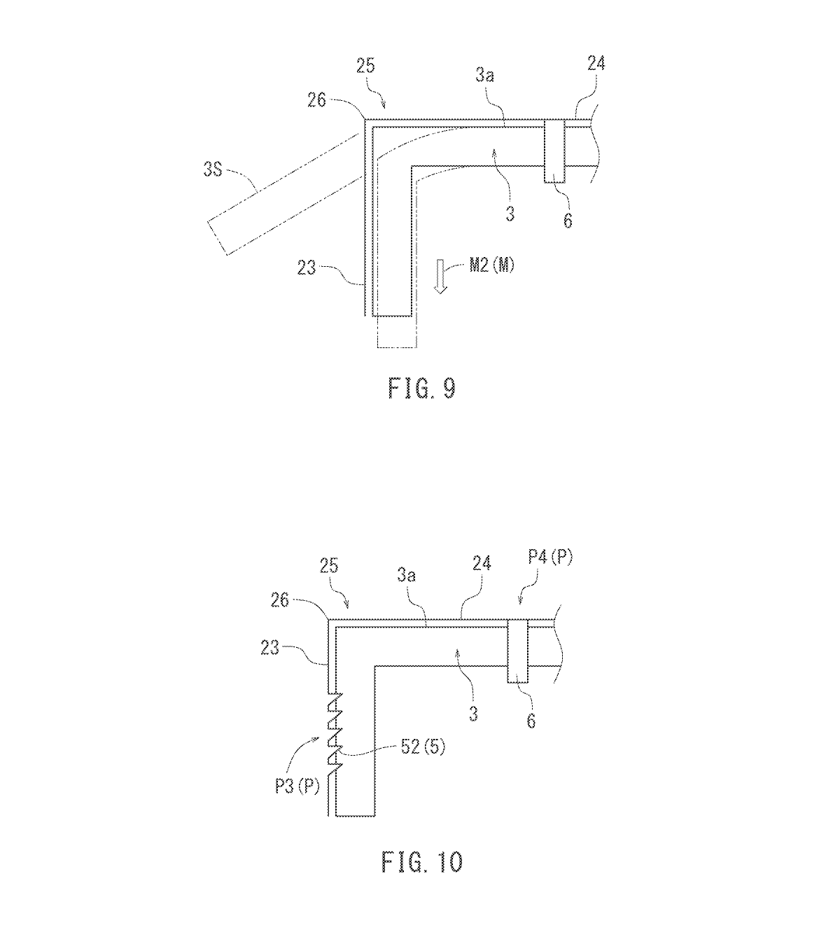

As shown in FIGS. 2 and 7, the dash panel 2 has a left corner 25 defining a connection portion 26 where a left face 23 and a front face 24 intersect. As shown in FIG. 8, the soundproofing material 3 is disposed across these intersecting faces, requiring deformation of the soundproofing material 3. In the present embodiment, mounting positions P3 and P4 of the soundproofing material 3 are set on the left face 23 and the front face 24 of the left corner 25, respectively. Consequently, as shown in FIG. 7, the soundproofing material 3 is subjected to both a first acting force M1 (caused by gravity) and a second acting force M2 (caused by the restoring force of the elastically deformed soundproofing material 3 attempting to return to its original state, as illustrated in FIG. 9).

To counteract these multidirectional forces, the mounting positions P3 and P4 utilizes the first protrusions 51 and second protrusions 52. The first protrusions 51 are oriented direction X1 such that their reverse direction Y1 faces downward (first acting direction) first acting force M1. The second protrusions 52 (as shown in FIG. 8) are oriented direction X2 such that their reverse direction Y2 faces rearward (second acting direction) the second acting force M2. Furthermore, the second protrusions 52 is strategically disposed closer to the connection portion 26, which is between the left face 23 and the front face 24 of the left corner 25, than the first protrusions 51 to maximize resistance against the restoring force.

As shown in FIG. 7, at the mounting position P4 on the front face 24 of the left corner 25, similar to the mounting position P on the left face 23, a plurality of first protrusions 51 are arranged in a row such that the reverse direction Y1 faces downward (first acting direction) in which the first acting force M1 acts. In addition, a plurality of second protrusions 52 are arranged in a row such that the reverse direction Y2 faces rightward (second acting direction) in which the second acting force M2 acts. The group of second protrusions 52 is disposed closer to the connection portion 26 at the left corner 25, i.e., closer to the left side than the group of first protrusions 51.

When disposing the soundproofing material 3 at the left corner 25, for example, the mounting surface 3a of the soundproofing material 3 may be slidably moved to be attached along the forward direction X1 of the first protrusions 51 provided on the left face 23 and the front face 24, respectively. Alternatively, the mounting surface 3a of the soundproofing material 3 may be slidably moved to be attached along the forward direction X2 of the second protrusions 52 on either the left face 23 or the front face 24.

As referring to FIG. 2, mounting positions P are also set at other locations on the dash panel 2. For example, mounting positions P are set at the right corner defined by the right face and the front face, in the same manner as the left corner 25, and a plurality of protrusions 5 may be disposed at each mounting position P.

The geometric parameters (shape, length, width, height) and the specific array pattern of the protrusions 5 may be adapted based on the material properties of the soundproofing material 3 and the anticipated magnitude of the acting forces M1, M2. For example, the cross-sectional shape, number of arrangements, and orientation of the protrusions 5 are set according to the material, density, and degree of interference with the protrusions 5 of the material constituting the soundproofing material 3. When arranging a plurality of protrusions 5 in alignment, they may be arranged in a plurality along the acting direction of the acting force M and a direction intersecting the acting direction of the acting force M, or they may be arranged in only one of those directions. In this way, by changing the shape, size, number of arrangements, and arrangement direction of the protrusions 5, the magnitude of the frictional force R acting between the protrusions 5 and the mounting surface 3a of the soundproofing material 3 can be adjusted.

In some variations, the protrusions 5 may employ only the second protrusions 52 arranged in alignment, for example, according to the magnitudes of the first acting force M1 and the second acting force M2 at the mounting position P. That is, the protrusions 5 may be constituted only with protrusions 5 arranged in the direction that provides greater frictional resistance against the second acting force M2. In this case, the frictional resistance against the first acting force M1 can restrict the movement of the soundproofing material 3 in the first acting direction by means of the lateral faces defining the inclined portion 5a of the protrusion 5.

When the soundproofing material 3 is disposed across a plurality of faces with different surface directions of the molded surface 2a and the mounting positions P are set on the plurality of faces, the soundproofing material 3 may be fixed with fasteners at some of the mounting positions P. For example, as shown in FIG. 10, a configuration may be adopted in which the protrusion 5 is disposed at the mounting position P3 of one of the left face 23 and the front face 24 of the left corner 25, and the soundproofing material 3 is fixed with the fastener 6 at the mounting position P4 of the other face.

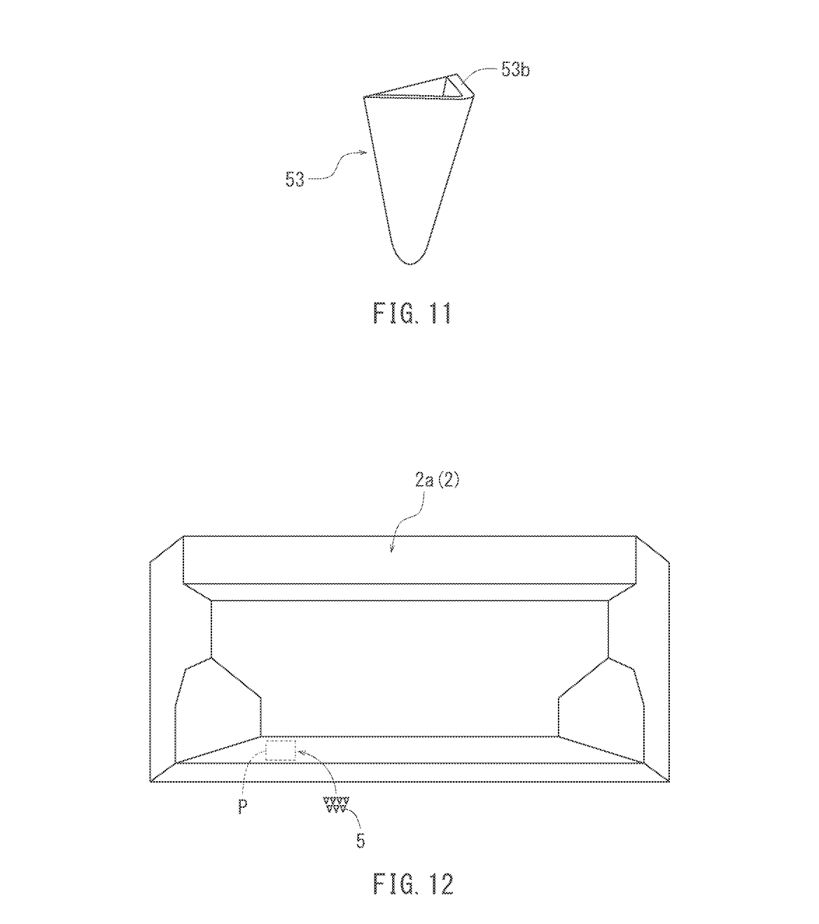

While the protrusion 5 may be formed as solid integral components of cast or molded, alternative manufacturing methods are contemplated. For instance, as shown in FIG. 11, if the dash panel 2 is a sheet metal stamping, a protrusion 53 may be formed as a hollow structure stamped directly into the sheet metal, wherein the locking portion 53b is defined by the edge of the thin plate. Both the protrusions 5 and 53, whether of solid or hollow construction, have the same effect of generating frictional resistance.

The protrusion 5 may be configured as a separate member instead of being formed integrally with the dash panel 2. For example, as shown in FIG. 12, in order to adjust the magnitude of the frictional resistance, a member constituting the protrusion 5 may be retrofitted to the mounting position P on the molded surface 2a. In this case, the protrusions 5 may be configured as individual separate members, or may be configured as a group of protrusions 5 in which a plurality of protrusions 5 are arranged on a single sheet member.

The cross-sectional shape of the protrusions 5 and 53 may be selected from various shapes including, in addition to a triangular shape, rectangular shapes, semicircular shapes, and the like.

The mounting structure 1 for automotive soundproofing material may be configured such that protrusions 5 are disposed at some of the plurality of mounting positions P on the dash panel 2, and attachment by the protrusions 5 and 53 and attachment by fasteners are used in combination, or the soundproofing material 3 may be attached by the protrusions 5 and 53 without using fasteners at all mounting positions P on the dash panel 2. The protrusions 5 and 53 may also serve as temporary fasteners when attaching the soundproofing material 3.

The mounting structure 1 for automotive soundproofing material is not limited to the dash panel 2, and may also be applied to other vehicle body panels such as a floor panel. It may also be applied to the attachment of soundproofing material 3 to a rear side of various interior trim components of an automobile, such as back door trim, package tray trim, deck side trim, door trim, and the like. This structure is broadly applicable to vehicles including gasoline vehicles, diesel vehicles, electric vehicles, hybrid vehicles, and the like. For example, it may also be applied to a panel that separates a motor room and a passenger compartment space of the electric vehicle.

### Effects of Embodiment

The mounting structure 1 for automotive soundproofing material according to the above embodiment has mounting positions P for attaching the soundproofing material 3 to the molded surface 2a of the dash panel 2 (vehicle body panel). At the mounting position P, the protrusion 5 projecting from the molded surface 2a is provided. A frictional force R may be generated between the mounting surface 3a of the soundproofing material 3 and the protrusion 5. This frictional force R acts with a magnitude equal to or greater than the acting force M that acts on the mounting surface 3a of the soundproofing material 3 due to the forces acting on the soundproofing material 3, tending to move the mounting surface 3a from the mounting position P along the surface direction of the molded surface 2a. As a result, the soundproofing material 3 is held at the mounting position P. With this configuration, the soundproofing material 3 can be attached without providing holes for fasteners such as bolts or clips. Therefore, holes that could cause noise leakage at the mounting position P where the protrusion 5 is provided may be eliminated. Degradation of the sound absorption performance and sound insulation performance of the soundproofing material 3 may be suppressed. Furthermore, by attaching the soundproofing material 3 without using fasteners, installation of the soundproofing material 3 to the dash panel 2 may be performed simply. This reduces the effort of the mounting work and shortens the man-hours. An effect of preventing incorrect installation may also be expected. Therefore, the efficiency of the mounting work for the soundproofing material 3 may be improved.

According to the above embodiment, the protrusion 5 has a shape in which the height of the protrusion changes along the acting direction in which the acting force M acts. In the forward direction X in which the height of the protrusion increases, the frictional resistance between the mounting surface 3a of the soundproofing material 3 and the protrusion 5 becomes relatively small. The direction of attaching the mounting surface 3a of the soundproofing material 3 along the molded surface 2a is aligned with the forward direction X. This allows the soundproofing material 3 to be smoothly attached to the molded surface 2a. Furthermore, the reverse direction Y of the protrusion 5 is set in the acting direction in which the acting force M acts. This causes the soundproofing material 3 mounted on the molded surface 2a to be locked by the locking portion 5b. The frictional resistance against the acting force M acts relatively large. Therefore, the soundproofing material 3 is held at the mounting position P, and positional displacement and the like caused by the acting force M may be prevented. Accordingly, positioning of the soundproofing material 3 relative to the molded surface 2a is facilitated.

According to the above embodiment, the soundproofing material 3 is disposed across a plurality of faces with different surface directions of the molded surface 2a. The mounting position P having the protrusion 5 is set on at least one of the plurality of faces. The face on which the second acting force M2 caused by the restoring force of the soundproofing material 3 acts is, for example, the left face 23 and the front face 24 of the left corner 25. On this face, the second protrusion 52 is arranged in the direction that provides greater frictional resistance against the second acting force M2. This makes it possible to prevent positional displacement of the soundproofing material 3 caused by the second acting force M2.

According to the above embodiment, the face on which the first acting force M1 caused by gravity and the second acting force M2 caused by the restoring force of the soundproofing material 3 act in different directions is, for example, the left face 23 and the front face 24 of the left corner 25. On this face, the first protrusion 51 and the second protrusion 52 are provided. The first protrusion 51 is arranged in the direction that provides greater frictional resistance against the first acting force M1. The second protrusion 52 is arranged in the direction that provides greater frictional resistance against the second acting force M2. With this configuration, frictional forces R that resist the acting forces M acting in two different directions respectively act, and the soundproofing material 3 may be held more effectively.

According to the above embodiment, on the face where the second acting force M2 caused by the restoring force of the soundproofing material 3 acts in the direction away from the connection portion 26 where two faces with different surface directions of the molded surface 2a are connected (e.g., the left face 23 and the front face 24 of the left corner 25), the second protrusion 52 is disposed closer to the connection portion 26 than the first protrusion 51. With this configuration, the frictional resistance against the second acting force M2 may be increased at a position closer to the connection portion 26. Therefore, positional displacement of the soundproofing material 3 caused by the second acting force M2 may be more effectively prevented.

According to the above embodiment, a plurality of protrusions 5 are arranged in alignment at the mounting position P of the soundproofing material 3 set on the dash panel 2. Frictional resistance is generated between the protrusions 5 and the mounting surface 3a of the soundproofing material 3. This holds the soundproofing material 3 at the mounting position P. The soundproofing material 3 is positioned relative to the molded surface 2a of the dash panel 2. Furthermore, the magnitude of the frictional force R may be adjusted by appropriately setting the shape, size, number of arrangements, and direction of the protrusions 5.

According to the above embodiment, the protrusion 5 is disposed at the mounting position P of the soundproofing material 3 on the dash panel 2. This makes it possible to reduce or eliminate the holes in the soundproofing material 3 for fasteners to pass through. Therefore, it is possible to prevent degradation of the performance of the soundproofing material 3 against noise and vibration. Furthermore, eliminating the need for fasteners for attaching the soundproofing material 3 may reduce the number of parts.

According to the above embodiment, the protrusion 5 has a forward direction X and a reverse direction Y. The reverse direction Y is the direction in which the height of the protrusion decreases from the locking portion 5b, which has the greatest protrusion height, toward the tip 5c. The protrusion 5 has the largest cross-sectional area at the locking portion 5b, and is tapered such that the height and width dimensions of the protrusion decrease toward the reverse direction Y. Therefore, by aligning the attachment direction of the soundproofing material 3 with the forward direction X, it becomes easier to attach the mounting surface 3a of the soundproofing material 3 along the molded surface 2a.

In the mounting structure 1 for automotive soundproofing material according to the above embodiment, the protrusion 5 is formed integrally with the dash panel 2 (vehicle body panel). Therefore, the number of parts may be reduced.

The mounting structure 1 for automotive soundproofing material according to the above embodiment may also have a configuration in which the protrusion 5 is disposed on the molded surface 2a as a separate member. In this case, the protrusion 5 may be retrofitted to the molded surface 2a. Therefore, by appropriately setting the number and orientation of the protrusions 5 to be disposed, the magnitude of the frictional resistance against the acting force M may be adjusted.

The mounting structure for automotive soundproofing material according to the present disclosure shall not be limited to the appearance and configuration described in the above embodiment, and may be implemented in various other forms by making various modifications, additions, deletions, and combinations of configurations without departing from the spirit of the present disclosure.

For example, the arrangement of the first protrusion and the second protrusion may be such that the first protrusion is disposed at a position closer to the connection portion where two faces with different surface directions of the molded surface are connected.

For example, a mounting position P having only one protrusion may be set.

In the above embodiment, an example has been shown in which the first acting force M1 caused by gravity and the second acting force M2 caused by the restoring force of the soundproofing material 3 act in different directions as the acting forces acting on the soundproofing material 3. The manner in which the acting forces act varies depending on the mounting position and orientation of the soundproofing material relative to the panel, and includes cases where only the first acting force acts, cases where only the second acting force acts, and the like. Furthermore, the acting direction of the acting forces includes both cases where only one direction is involved and cases where two or more directions are involved.

For example, vehicle body panels include various types such as panels welded as part of the main body and panels connected in a later assembly process.

1. A mounting structure for an automotive soundproofing material, comprising:
a base component having a surface;
a protrusion projecting from the surface, the protrusion defining a locking surface; and
a soundproofing material disposed along the surface,
wherein the locking surface is oriented to face an acting force acting on the soundproofing material, thereby restricting movement of the automotive soundproofing material relative to the base component.

2. The mounting structure according to claim 1, wherein the protrusion comprises an inclined portion extending from the locking surface, such that a protruding height from the surface gradually decreases from the locking surface along a direction of the acting force.

3. The mounting structure according to claim 2, wherein the inclined portion comprises a tapered shape having a width that decreases from the locking surface toward a tip of the inclined portion.

4. The mounting structure according to claim 1, wherein the soundproofing material is disposed along the surface in an elastically deformed state, and the acting force comprises gravity and a restoring force of the soundproofing material.

5. The mounting structure according to claim 4 further comprises a plurality of protrusions including at least one first protrusion and at least one second protrusion, wherein the locking surface of the at least one first protrusion is oriented to face a first acting direction to resist a first acting force caused by gravity, and the locking surface of the at least one second protrusion is oriented to face a second acting direction to resist a second acting force caused by the restoring force.

6. The mounting structure according to claim 5, wherein the surface further comprises a plurality of faces facing different directions intersecting at a connection portion, and
wherein the at least one second protrusion is disposed closer to the connection portion than the at least one first protrusion.

7. The mounting structure according to claim 1, wherein the surface further comprises a plurality of faces facing different directions intersecting at a connection portion.

8. The mounting structure according to claim 1, wherein the base component is a vehicle body panel, and the surface is recessed as viewed from a passenger compartment side.

9. The mounting structure according to claim 1, wherein the protrusion is a hollow structure formed integrally with the base component.

10. The mounting structure according to claim 1, wherein the protrusion is a separate attached to the surface of base component.

11. A vehicle body panel configured to retain an automotive soundproofing material, comprising:
a panel body defining a molded surface; and
a plurality of protrusions projecting from the molded surface, the plurality of protrusions arranged in alignment at a mounting position, wherein at least one of the protrusions includes a locking portion and an inclined portion, the at least one of the protrusions having a height that decreases from the locking portion along the inclined portion in a reverse direction to facilitate sliding installation of the automotive soundproofing material in a forward direction, and wherein the locking portion is configured to resist movement of the automotive soundproofing material in the reverse direction.

12. The vehicle body panel of claim 11, wherein the panel body is formed of sheet metal, and the plurality of protrusions are hollow structures formed integrally with the sheet metal.

13. The vehicle body panel of claim 11, wherein the molded surface comprises a left face and a front face connecting at a corner, and the plurality of protrusions are disposed on at least one of the left face and the front face.

14. The vehicle body panel of claim 11, wherein the plurality of protrusions includes a first group of protrusions oriented in a first direction and a second group of protrusions oriented in a second direction different from the first direction.

15. A method of installing an automotive soundproofing material, the method comprising:
providing a base component having a surface and at least one protrusion projecting therefrom, the protrusion having a reverse direction with a decreasing protrusion height and a forward direction defining a locking surface;
aligning the automotive soundproofing material with the surface;
sliding the automotive soundproofing material along the surface in the forward direction; and
engaging the automotive soundproofing material against the locking surface to resist an acting force and restrict movement of the automotive soundproofing material in the reverse direction.

16. The method of claim 15, wherein the step of sliding the automotive soundproofing material further comprises elastically deforming the soundproofing material to conform to a plurality of faces of the base component having different surface directions.

17. The method of claim 15, wherein the acting force comprises a restoring force generated by elastically deformed automotive soundproofing material tending to return to its original shape.

18. The method of claim 15 further comprises securing the automotive soundproofing material to the base component with a mechanical fastener at a location spaced apart from the at least one protrusion.
